(19) United States
(12) Patent Application Publication
(10) Pub. No.: US 2026/0369282 A1
(43) Pub. Date: Nov. 19, 2026

(54) PRIORITY VALUES FOR PARAMETRIC SPATIAL AUDIO ENCODING

(71) Applicant: NOKIA TECHNOLOGIES OY, Espoo (FI)

(72) Inventors: Adriana VASILACHE, Tampere (FI); Mikko-Ville LAITINEN, Espoo (FI)

(21) Appl. No.: 19/158,804

(22) PCT Filed: Feb. 1, 2024
(86) PCT No.: PCT/EP2024/052440

§ 371 Date: Aug. 21, 2025

(30) Foreign Application Priority Data
Feb. 24, 2023 (GB) 2302669.3

(51) Int. Cl. G10L 19/008; G10L 19/002; G10L 19/032

(52) U.S. Cl. CPC G10L 19/008; G10L 19/002; G10L 19/032

(57) ABSTRACT

An apparatus configured to: receive a plurality of audio objects each comprising a respective audio signal and directional metadata; separate at least one audio object from the plurality of audio objects to give at least one separated audio object and a remaining plurality of audio objects; determine a priority value associated for each of the remaining plurality of audio objects; determine a priority value for the at least one separated audio object dependent on an audio signal type of the audio signal associated with the at least one separated audio object and the priority values of the remaining plurality of audio objects; determine a quantization bit allocation for directional metadata associated with the at least one separated audio object based on the priority value for the at least one separated audio object; and quantize the directional metadata associated with the at least one separated audio object based on the quantization bit allocation.

### FIELD

The present application relates to apparatus and methods for spatial audio representation and encoding, but not exclusively for audio representation for an audio encoder.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata (which may also include other parameters such as surround coherence, spread coherence, number of directions, distance etc) for an audio codec. For example, these parameters can be estimated from microphone-array captured audio signals, and for example a stereo or mono signal can be generated from the microphone array signals to be conveyed with the spatial metadata. The stereo signal could be encoded, for example, with an AAC encoder and the mono signal could be encoded with an EVS encoder. A decoder can decode the audio signals into PCM signals and process the sound in frequency bands (using the spatial metadata) to obtain the spatial output, for example a binaural output.

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

The aforementioned immersive audio codecs are particularly suitable for encoding captured spatial sound from microphone arrays (e.g., in mobile phones, VR cameras, stand-alone microphone arrays). However, such an encoder can have other input types, for example, loudspeaker signals, audio object signals, Ambisonic signals.

### SUMMARY

According to a first aspect there is an apparatus comprising means configured to: receive a plurality of audio objects each comprising a respective audio signal and directional metadata; separate at least one audio object from the plurality of audio objects to give at least one separated audio object and a remaining plurality of audio objects; determine a priority value associated for each of the remaining plurality of audio objects; determine a priority value for the at least one separated audio object dependent on an audio signal type of the audio signal associated with the at least one separated audio object and the priority values of the remaining plurality of audio objects; determine a quantization bit allocation for directional metadata associated with the at least one separated audio object based on the priority value for the at least one separated audio object; and quantize the directional metadata associated with the at least one separated audio object based on the quantization bit allocation.

The means configured to determine a priority value for the at least one separated audio object dependent on an audio signal type of the audio signal associated with the at least one separated audio object and the priority values of the remaining plurality may be configured to: determine whether the audio signal type of the audio signal associated with the at least one separated audio object warrants a highest priority value; or determine whether the audio signal type of the audio signal associated with the at least one separated audio object warrants a lowest priority value; or otherwise determine that the separated audio object has a further priority value.

The highest priority value may be a highest priority value that can be determined for an audio object of the remaining plurality of audio objects.

The highest priority value may be one;

The lowest priority value may be a maximum priority value of the priority values of the remaining audio objects;

The further priority value may be the mid value between a highest priority value that can be determined for an audio object of the remaining plurality of audio objects and a maximum priority value of the priority values of the remaining audio objects.

Alternatively, the further priority value may be a predetermined value.

The apparatus may further comprise means configured to: encode the audio signal of the at least one separated audio object using an audio encoder, and analyse the audio signal of the at least one separated audio object using an audio signal type determiner from the audio encoder.

According to a second aspect there is a method comprising: receiving a plurality of audio objects each comprising a respective audio signal and directional metadata; separating at least one audio object from the plurality of audio objects to give at least one separated audio object and a remaining plurality of audio objects; determining a priority value associated for each of the remaining plurality of audio objects; determining a priority value for the at least one separated audio object dependent on an audio signal type of the audio signal associated with the at least one separated audio object and the priority values of the remaining plurality of audio objects; determining a quantization bit allocation for directional metadata associated with the at least one separated audio object based on the priority value for the at least one separated audio object; and quantizing the directional metadata associated with the at least one separated audio object based on the quantization bit allocation.

Determining a priority value for the at least one separated audio object dependent on an audio signal type of the audio signal associated with the at least one separated audio object and the priority values of the remaining plurality may comprise: determining whether the audio signal type of the audio signal associated with the at least one separated audio object warrants a highest priority value; or determining whether the audio signal type of the audio signal associated with the at least one separated audio object warrants a lowest priority value; or otherwise determining that the separated audio object has a further priority value.

The highest priority value may be a highest priority value that can be determined for an audio object of the remaining plurality of audio objects.

The highest priority value may be one;

The lowest priority value may be a maximum priority value of the priority values of the remaining audio objects.

The further priority value may be the mid value between a highest priority value that can be determined for an audio object of the remaining plurality of audio objects and a maximum priority value of the priority values of the remaining audio objects.

Alternatively the further priority value may be a predetermined value.

The method may further comprise: encoding the audio signal of the at least one separated audio object using an audio encoder, and analysing the audio signal of the at least one separated audio object using an audio signal type determiner from the audio encoder.

According to a third aspect there is an apparatus comprising at least one processor and at least one memory including computer program code, the at least one memory and the computer program code configured to, with the at least one processor, cause the apparatus to at least to: receive a plurality of audio objects each comprising a respective audio signal and directional metadata; separate at least one audio object from the plurality of audio objects to give at least one separated audio object and a remaining plurality of audio objects; determine a priority value associated for each of the remaining plurality of audio objects; determine a priority value for the at least one separated audio object dependent on an audio signal type of the audio signal associated with the at least one separated audio object and the priority values of the remaining plurality of audio objects; determine a quantization bit allocation for directional metadata associated with the at least one separated audio object based on the priority value for the at least one separated audio object; and quantize the directional metadata associated with the at least one separated audio object based on the quantization bit allocation.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system or apparatus suitable for implementing some embodiments;

FIG. 2 shows schematically an example encoding mode selector as shown in the system of apparatus as shown in FIG. 1 according to some embodiments;

FIG. 3 shows a flow diagram of the operation of the example encoding mode selector shown in FIG. 2 according to some embodiments;

FIG. 4 shows a flow diagram of the operation of the example first, lowest, or only MASA bitrate encoding mode shown in FIG. 3 according to some embodiments;

FIG. 5 shows a flow diagram of the operation of the example second, lower, or object information encoding mode shown in FIG. 3 according to some embodiments;

FIG. 6 shows a flow diagram of the operation of the example third, higher, or single object encoding mode shown in FIG. 3 according to some embodiments;

FIG. 7 shows a flow diagram of the operation of the example fourth, highest, or independent object and multi-input encoding mode shown in FIG. 3 according to some embodiments;

FIG. 8 shows schematically an example audio object metadata encoder as shown in FIG. 1 with respect to the fourth encoding mode according to some embodiments;

FIG. 9 shows a flow diagram of the operation of the example audio object metadata encoder encoding mode selector shown in FIG. 8 according to some embodiments;

FIG. 10 shows schematically a system or apparatus suitable for implementing a single object encoding mode of the flow diagram of FIG. 6 according to some embodiments;

FIG. 11 shows a flow diagram of an operation of the example object priority determiner in FIG. 8 according to some embodiments; and

FIG. 12 shows an example device suitable for implementing the apparatus shown in previous figures.

### EMBODIMENTS OF THE APPLICATION

The following describes in further detail suitable apparatus and possible mechanisms for the encoding of parametric spatial audio signals comprising transport audio signals and spatial metadata. As indicated above immersive audio codecs (such as 3GPP IVAS) are being planned which support a multitude of operating points ranging from a low bit rate operation to transparency. It is expected to support channel-based audio and scene-based audio inputs including spatial information about the sound field and sound sources. In the following the example codec is configured to be able to receive multiple input formats. In particular the codec is configured to obtain or receive a multi audio signal (for example received from a microphone array, or as a multi-channel audio format input, an ambisonics format input) and one or more audio object signal (these can also be called an independent stream with metadata—ISM format). Furthermore, in some situations the codec is configured to handle more than one input format at a time. This combined (input) format mode can, for example, enable simultaneous encoding of two different audio input formats. An example of two different audio input formats being currently considered is the combination of the MASA format with audio object format. Metadata-Assisted Spatial Audio (MASA) is an example of a parametric spatial audio format and representation suitable as an input format for IVAS.

It can be considered as an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total energy ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example, a reasonable design choice which is able to produce a good quality output is one where the spatial metadata comprises one or more directions for each time-frequency subframe (and associated with each direction direct-to-total ratios, spread coherence, distance values etc) are determined.

The concept as discussed in further detail herein is the definition of a multi-rate coding model which provides for encoding of a combined format at various bitrates. This coding model enables a parametric encoding of the audio object input that includes variable rate encoding for an object direction parameter based on a determined priority of the object and the available bitrate. Thus there comprises embodiments as discussed in further detail herein of apparatus and methods for defining a quantization resolution of the audio object metadata as a function of both the MASA-to-total energy ratios and ISM ratios. Based on these parameters a priority value is calculated for each object and it is used to change the audio object metadata quantization resolution. Furthermore, there also comprises embodiments where the priority of object metadata is found for a case of when an audio object or more than one audio object is separated from the general audio object stream comprising multiple audio objects.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

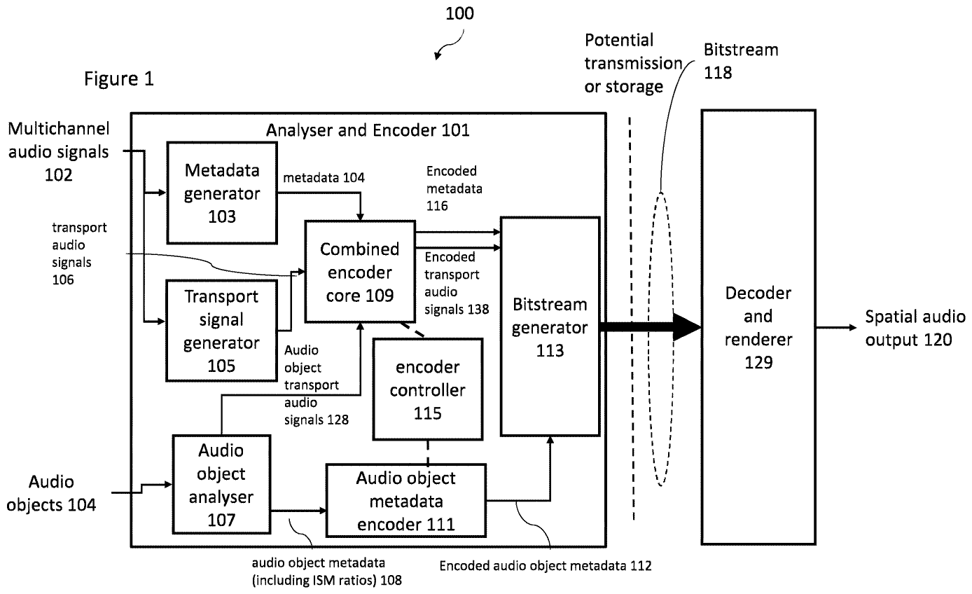

In this regard FIG. 1 depicts an example apparatus 100 and system for implementing embodiments of the application. The system is shown with an ‘analysis’ part. The ‘analysis’ part is the part from receiving the multi-channel signals up to an encoding of the metadata and downmix signal.

The input to the system ‘analysis’ part is the multi-channel audio signals 102. In the following examples a microphone channel signal input is described, however any suitable input (or synthetic multi-channel) format may be implemented in other embodiments. For example, in some embodiments the spatial analyser and the spatial analysis may be implemented external to the encoder. For example, in some embodiments the spatial (MASA) metadata associated with the audio signals may be provided to an encoder as a separate bit-stream. In some embodiments the spatial (MASA) metadata may be provided as a set of spatial (direction) index values.

Additionally, FIG. 1 also depicts multiple audio objects 104 as a further input to the analysis part. As mentioned above these multiple audio objects (or audio object stream) 104 may represent various sound sources within a physical space. Each audio object may be characterized by an audio (object) signal and accompanying metadata comprising directional data (in the form of azimuth and elevation values) which indicate the position or direction of the audio object within a physical space on an audio frame basis.

The multi-channel signals 102 are passed to an analyser and encoder 101, and specifically a transport signal generator 105 and to a metadata generator 103.

In some embodiments the metadata generator 103 is also configured to receive the multi-channel signals and analyse the signals to produce metadata 104 associated with the multi-channel signals and thus associated with the transport signals 106. The analysis processor 103 may be configured to generate the metadata which may comprise, for each time-frequency analysis interval, a direction parameter and an energy ratio parameter and a coherence parameter (and in some embodiments a diffuseness parameter). The direction, energy ratio and coherence parameters may in some embodiments be considered to be MASA spatial audio parameters (or MASA metadata). In other words, the spatial audio parameters comprise parameters which aim to characterize the sound-field created/captured by the multi-channel signals (or two or more audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The transport signals 106 and the metadata 104 may be passed to a combined encoder core 109.

In some embodiments the transport signal generator 105 is configured to receive the multi-channel signals and generate a suitable transport signal comprising a determined number of channels and output the transport signals 106 (MASA transport audio signals). For example, the transport signal generator 105 may be configured to generate a 2-audio channel downmix of the multi-channel signals. The determined number of channels may be any suitable number of channels. The transport signal generator in some embodiments is configured to otherwise select or combine, for example, by beamforming techniques the input audio signals to the determined number of channels and output these as transport signals.

In some embodiments the transport signal generator 105 is optional and the multi-channel signals are passed unprocessed to a combined encoder core 109 in the same manner as the transport signal are in this example.

The audio objects 104 may be passed to the audio object analyser 107 for processing. In some embodiments the audio object analyser 107 analyses the object audio input stream 104 in order to produce suitable audio object transport signals and audio object metadata. For example, the audio object analyser may be configured to produce the audio object transport signals 128 by downmixing the audio signals of the audio objects into a stereo channel together using amplitude panning based on the associated audio object directions. Additionally, the audio object analyser may also be configured to produce the audio object metadata associated with the audio object input stream 104. The audio object metadata may comprise direction values which are applicable for all sub-bands. So, if there are 4 objects, there are 4 directions. In the examples described herein the direction values also apply across all of the subframes of the frame, but in some embodiments the temporal resolution of the direction values can differ and the directions values apply for one or more than one sub-frames of the frame. Furthermore, energy ratios (or ISM ratios) may be determined for each object. The energy ratio (ISM ratio) defines the contribution of the object within the object part of the total audio environment. In the following examples the energy ratios (or ISM ratios) are for each time-frequency tile for each object.

In some embodiments, the audio object analyser 107 may be sited elsewhere and the audio objects 104 input to the analyser and encoder 101 is audio object transport signals and audio object metadata.

The analyser and encoder 101 may comprise a combined encoder core 109 which is configured to receive the transport audio (for example downmix) signals 106 and audio object transport signals 128 in order to generate a suitable encoding of these audio signals.

The analyser and encoder 101 may also comprise an audio object metadata encoder 111 which is similarly configured to receive the audio object metadata 108 and output an encoded or compressed form of the input information as encoded audio object metadata 112.

In some embodiments the combined encoder core can be configured to implement a stream separation metadata determiner and encoder which can be configured to determine the relative contributory proportions of the multi-channel signals 102 (MASA audio signals) and audio objects 104 to the overall audio scene. This measure of proportionality produced by the stream separation metadata determiner and encoder may be used to determine the proportion of quantizing and encoding “effort” expended for the input multi-channel signals 102 and the audio objects 104. In other words, the stream separation metadata determiner and encoder may produce a metric which quantifies the proportion of the encoding effort expended on the multichannel audio signals 102 compared to the encoding effort expended on the audio objects 104. This metric may be used to drive the encoding of the audio object metadata 108 and the metadata 104. Furthermore, the metric as determined by the separation metadata determiner and encoder may also be used as an influencing factor in the process of encoding the transport audio signals 106 and audio object transport audio signal 128 performed by the combined encoder core 109. The output metric from the stream separation metadata determiner and encoder can furthermore be represented as encoded stream separation metadata and be combined into the encoded metadata stream from the combined encoder core 109.

In some embodiments the analyser and encoder 101 comprises a bitstream generator 113 configured to obtain the encoded metadata 116, the encoded transport audio signals 138 and the encoded audio object metadata 112 and generate the bitstream 118 for potential transmission or storage.

In some embodiments the analyser and encoder 101 comprises an encoder controller 115. The encoder controller 115 can in some embodiments control the encoding implemented by the audio object metadata encoder 111 and the combined encoder core 109. In some embodiments encoder controller 115 is configured to determine the bitrate for the bitstream 118 and based on the bitrate control the encoding. In some embodiments the encoder controller 115 is further configured to control at least one of the audio object analyser 107, transport signal generator 105 and metadata generator in generating parameters.

The analyser and encoder 101 can in some embodiments be a computer or mobile device (running suitable software stored on memory and on at least one processor), or alternatively a specific device utilizing, for example, FPGAs or ASICs. The encoding may be implemented using any suitable scheme. In some embodiments the encoder 107 may further interleave, multiplex to a single data stream or embed the encoded MASA metadata, audio object metadata and stream separation metadata within the encoded (downmixed) transport audio signals before transmission or storage shown in FIG. 1 by the dashed line. The multiplexing may be implemented using any suitable scheme.

Furthermore, with respect to FIG. 1 is shown an associated decoder and renderer 129 which is configured to obtain the bitstream 118 comprising encoded metadata 116, Encoded transport audio signals 138 and encoded audio object metadata 112 and from these generate suitable spatial audio output signals. The decoding and processing of such audio signals are known in principle and are not discussed in detail hereafter other than the decoding of the encoded ISM ratio metadata.

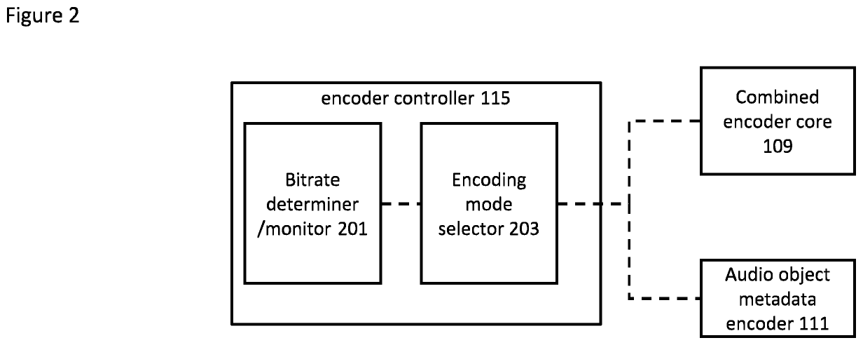

With respect to FIG. 2 is shown in further detail the encoder controller 115 according to some embodiments.

In this example the encoder controller 115 comprises a bitrate determiner/monitor 201 configured to determine and/or monitor the available bitrate for the bandwidth for the encoded audio and metadata. This could be determined based on a transmission path bandwidth estimation (and for example be based on an estimated signal strength) or a bandwidth storage determination to maintain the file for a determined time to be below a required size or by any suitable manner.

The bitrate determiner/monitor 201 can furthermore be configured to control an encoding mode selector 203. The encoder controller 115 can comprise a encoding mode selector 203 configured to select an encoding mode, for example based on the determined bandwidth or bitrate and then control the encoders, for example the combined encoder core 109 and audio object metadata encoder 111.

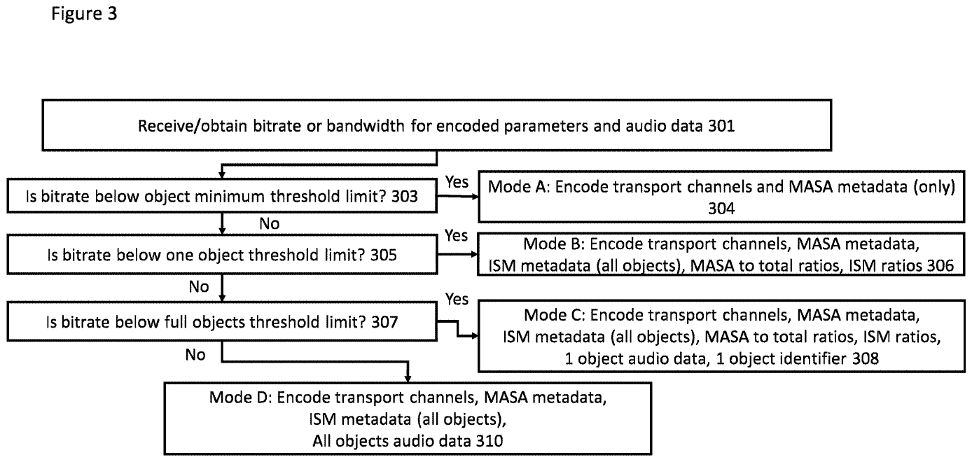

With respect to FIG. 3 is shown a flow diagram of an example operation of the encoder controller shown in FIG. 2 In this example there is an initial operation of receiving or obtaining or otherwise determining the bitrate or bandwidth for encoded parameters and audio data as shown in FIG. 3 by step 301.

Having obtained the available bandwidth or bitrate then a check can be made to determine whether the bitrate is below a first (or lowest or object minimum) threshold limit as shown in FIG. 3 by step 303.

Where the available bandwidth or bitrate is below the first (or lowest or object minimum) threshold limit then the encoders can be controlled to encode the transport channels and MASA metadata only (also shown as Mode A) as shown in FIG. 3 by step 304.

Where the available bandwidth or bitrate is above the first (or lowest or object minimum) threshold limit then a further check can be made to determine whether the bitrate is below a second (or lower or one object) threshold limit as shown in FIG. 3 by step 305.

Where the available bandwidth or bitrate is below the second (or lower or one object) threshold limit then the encoders can be controlled to encode transport channels, MASA metadata, ISM metadata (all objects), MASA to total ratios, ISM ratios (also shown as Mode B) as shown in FIG. 3 by step 306.

Where the available bandwidth or bitrate is above the second (or lower or one object) threshold limit then a further check can be made to determine whether the bitrate is below a third, higher or full object threshold limit as shown in FIG. 3 by step 307.

Where the available bandwidth or bitrate is below the third, higher or full object threshold limit then the encoders can be controlled to encode transport channels, MASA metadata, ISM metadata (all objects), MASA to total ratios, ISM ratios, and 1 object audio data, with 1 object identifier (also shown as Mode C) as shown in FIG. 3 by step 308.

Where the available bandwidth or bitrate is above the third, higher or full object threshold limit then the encoders can be controlled to encode transport channels, MASA metadata, ISM metadata (all objects), All objects audio data (also shown as Mode D) as shown in FIG. 3 by step 310.

The encoding modes can for example be summarised by the following table

| Mode | Bitrate range/Format | Encoded parameters |
|---|---|---|
| A | −32 kbps | transport channels |
| | | MASA metadata |
| B | 48-80 kbps | Transport channels |
| | ISM_MASA_MODE_PARAM | MASA metadata |
| | | ISM metadata |
| | | MASA to total ratios |
| | | ISM ratios |
| C | 96-128 kbps | Transport channels |
| | ISM_MASA_MODE_ONE_OBJ | MASA metadata |
| | | ISM metadata |
| | | MASA to total ratios |
| | | ISM ratios |
| | | 1 object audio data |
| | | 1 object identifier |
| D | 160 - | MASA Transport |
| | ISM_MASA_MODE_DISC | channels |
| | | MASA metadata |
| | | ISM metadata |
| | | all objects audio data |

The bitrates shown herein are examples and it would be understood that they can be other specific values.

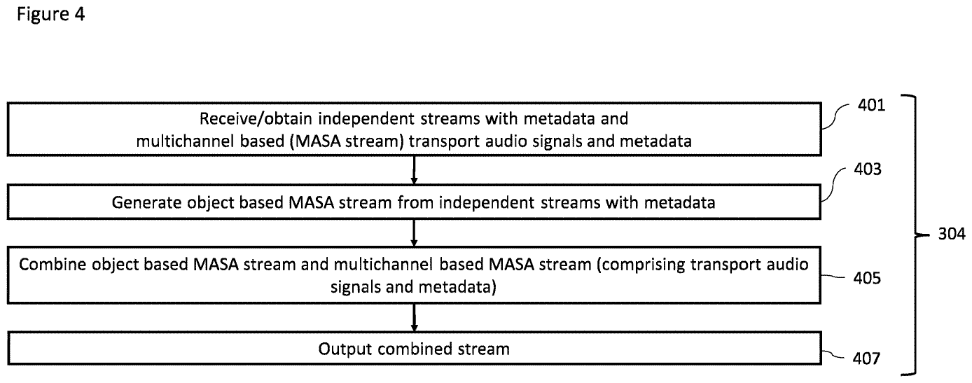

With respect to FIGS. 4 to 7 is shown flow diagrams showing a first (or lowest or combined) encoding mode as shown in FIG. 3 by step 304, a second (or lower or object metadata) encoding mode as shown in FIG. 3 by step 306, a third (or higher or one object) encoding mode as shown in FIG. 3 by step 308 and a fourth (or highest or all objects) encoding mode as shown in FIG. 3 by step 310 respectively.

For example FIG. 4 the mode A encoding method, shows the first (or lowest or combined) encoding mode as shown in FIG. 3 by step 304 in further detail. Thus for very low total bitrates (for example less or equal to 32 kbps) all encoding is implemented using a MASA representation.

Thus for example there is an operation of receiving/obtaining the object based streams (independent streams with metadata) and multichannel based (MASA stream) transport audio signals and metadata as shown in FIG. 4 by step 401.

Then, as shown in FIG. 4 by step 403, there is an operation of generating an object based MASA stream from the object streams (independent streams with metadata). This object based MASA stream can in some embodiments be created from the object stream using, for example, the methods presented in WO2019086757A1.

After this, as shown in FIG. 4 by step 405, the object based MASA stream and multichannel based MASA stream are combined. In some embodiments the original MASA stream and the MASA stream created from the objects can be combined using the method presented in GB2574238. The decoder gets the objects and the MASA audio content in the MASA format.

Then the combined stream is output as shown in FIG. 4 by step 407. In such embodiments the object audio content (together with the MASA audio content) is present in the decoded audio scene, but the objects cannot be edited nor separated from the scene at the decoder.

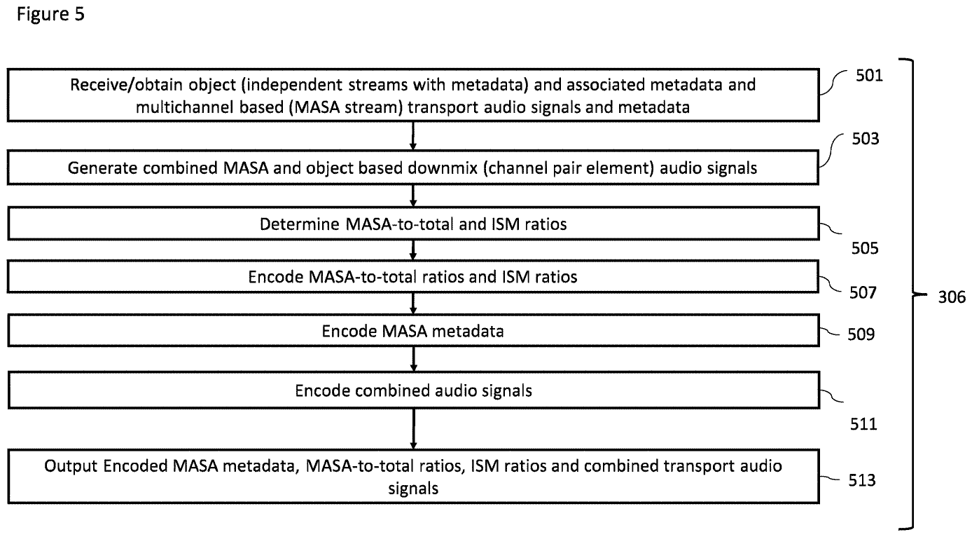

FIG. 5 shows the mode B encoding method, the second (or lower or object metadata) encoding mode as shown in FIG. 3 by step 306. Thus for low bit-rates (for example between 48 kbps and 80 kbps) and since there are a more bits available, there is a possibility to parameterize the audio scene, by sending one common audio data downmix, the MASA metadata, the ISM metadata, and additional parameter sets indicating for each time frequency tile how much of the signal corresponds to the MASA component out of the total audio scene (in other words this can be presented or indicated by the MASA-to-total energy ratios) and ratios indicating how the audio scene corresponding to the objects is distributed between the ISMs (in other words this can be presented or indicated by the ISM ratios).

Thus for example there is a method step of receiving/obtaining the object based streams (independent streams with metadata) and multichannel based (MASA stream) transport audio signals and metadata as shown in FIG. 5 by step 501.

Then, as shown by step 503 in FIG. 5, generate a combined MASA and object based downmix (channel pair element) audio signals. In other words, the audio content of MASA and the objects is downmixed to 2 channels (channel pair element CPE).

The MASA-to-total ratios and the ISM ratios can be determined as shown in FIG. 5 by step 505.

The MASA-to-total ratios and the ISM ratios can then be encoded based on any suitable encoding method. For example the ISM ratios can be encoded using a lattice encoding or other vector quantization method or the MASA-to-total ratios encoded by DCT transforming followed by entropy coding. (for example such as described in WO2022/200666). The encoding of the MASA-to-total ratios and the ISM ratios is shown in FIG. 5 by step 507.

Furthermore, the MASA metadata can then be encoded based on any suitable MASA metadata encoding method as shown in FIG. 5 by step 509.

The combined audio signals can then be encoded based on any suitable audio signal encoding method as shown in FIG. 5 by step 511.

The encoder can then output Encoded MASA metadata, MASA-to-total ratios, ISM ratios and combined transport audio signals as shown in FIG. 5 by step 513.

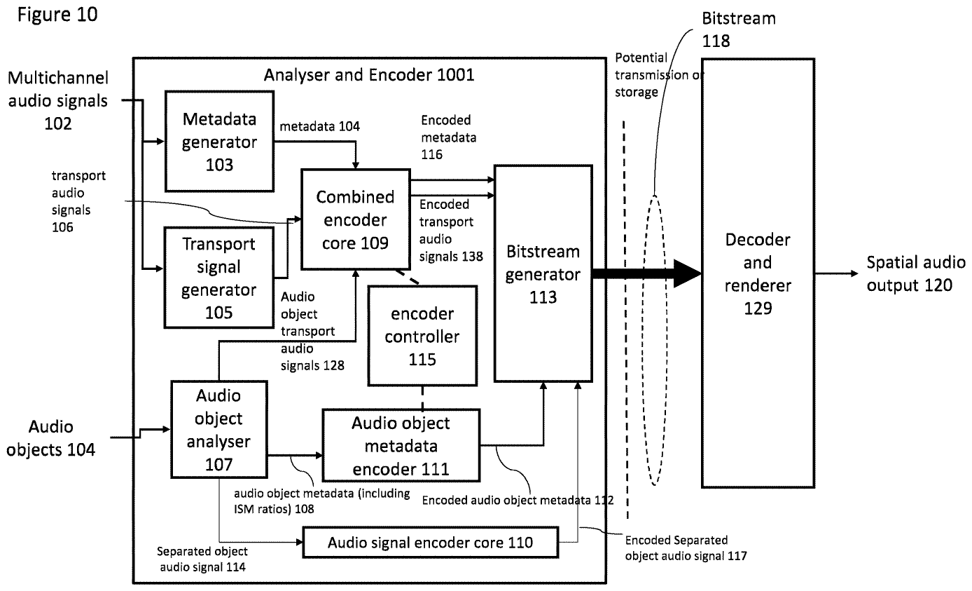

FIG. 10 shows a specific analyser and encoder 1001 for operating in the mode C method of encoding. It can be seen that the analyser and encoder 1001 has similar processing blocks to that of the analyser and encoder 101 in FIG. 1 with the addition of extra processing blocks for the processing and handling of the separated audio object. For the sake of brevity, the following will describe only those functional blocks which are involved in the handling of the separated audio object.

As before the audio object stream 104 is shown as being received by the audio object analyser 107. The audio object analyser 107 may be additionally configured to determine an audio object for separation from the stream of audio objects 104 and create the associated separated object audio signal 114. In embodiments this can be a mono audio signal. The separated audio object audio signal may then be encoded by an audio signal encoder 110 (such as an EVS encoder) to form the encoded separated object audio signal 117. This encoded separated object audio signal 117 may then be forwarded to the Bitstream generator 113 to form part of the bitstream 118. In embodiments the audio signal encoder 110 may be a mono channel encoder of IVAS.

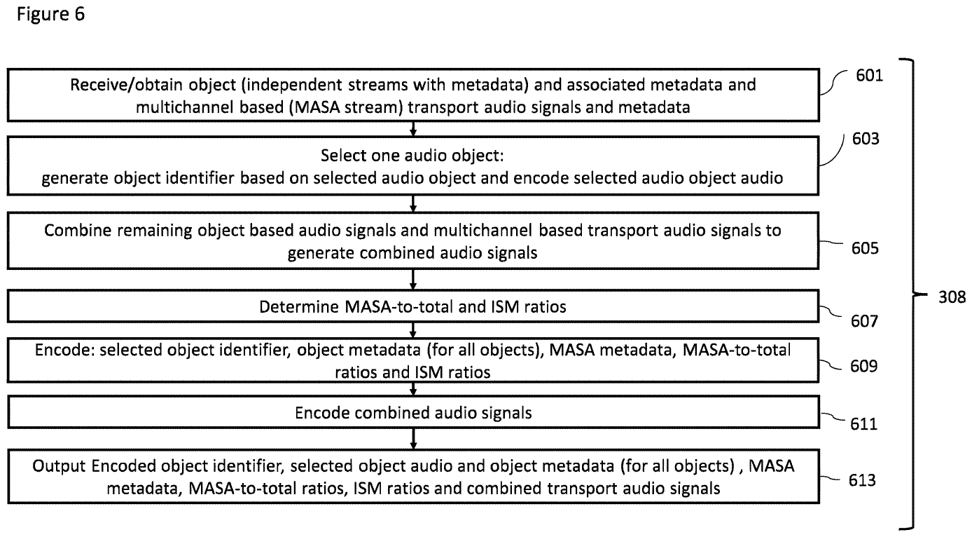

FIG. 6 shows the mode C encoding method, the third (or higher or one object) encoding mode as shown in FIG. 3 by step 308. Thus in medium or higher bitrates (for example bitrates larger or equal to 96 kbps and lower than 160 kbps), the audio content of one object is separated and sent independently. In addition, the downmix formed from the MASA transport channels and the rest of the objects are sent under MASA format with the additional parameters of the MASA-to-total energy ratios and ISM ratios. Moreover, the ISM metadata is sent, and an identifier describing which object was separated. At each frame it is decided which object is to be separated. The decision may, e.g., be based on the relative level of the objects with respect to other objects (e.g., separate the loudest object). This is explained in detail in WO2022/214730.

Thus, for example there is a method step of receiving/obtaining the object based streams (independent streams with metadata) and multichannel based (MASA stream) transport audio signals and metadata as shown in FIG. 6 by step 601.

Then, as shown by step 603 in FIG. 6, one audio object is selected and an object identifier generated based on selected audio object. Furthermore, the audio signal associated with the selected audio object is encoded. Any suitable audio signal encoder may be used for encoding the audio signal of the selected object. For example, the same or similar audio signal encoder as used for encoding the MASA audio signal(s) can be employed. Then a combined MASA and remaining (or non-selected) object based transport audio signals (or downmix) is generated as shown by FIG. 6 by step 605. The object transport signals can be created in the same manner as presented in the previous mode, mode B, with the difference being that the selected or separated object not included within the mix. For example, the multichannel or MASA audio signals and the (non-selected) object transport signals can be summed together to generate the combined transport audio signals.

The MASA-to-total ratios and the ISM ratios can be determined as shown in FIG. 6 by step 607.

The object identifier, MASA metadata, object metadata for all objects, MASA-to-total ratios and the ISM ratios can then be encoded based on any suitable encoding method as shown in FIG. 6 by step 609. For example, the encoding can employ any scalar or vector quantizer followed or not by entropy coding. The encoding of the MASA-to-total energy ratio encoding can be implemented in the manner as described in WO2022/200666. The encoding of the ISM ratios is described later in further detail.

The combined audio signals can then be encoded based on any suitable MASA audio signal encoding method as shown in FIG. 6 by step 611. The encoding is of the combined transport audio signals can employ any suitable transport audio signal encoding, for example the MASA encoder.

In other words the separated object is determined, separated and encoded as described in WO2022/214730, and for the remaining objects and the MASA stream the processing works as was described in WO2022/200666.

The encoder can then output the encoded object identifier, MASA metadata, MASA-to-total ratios, ISM ratios, object metadata (for all objects), selected single object audio signal and combined transport audio signals as shown in FIG. 6 by step 613.

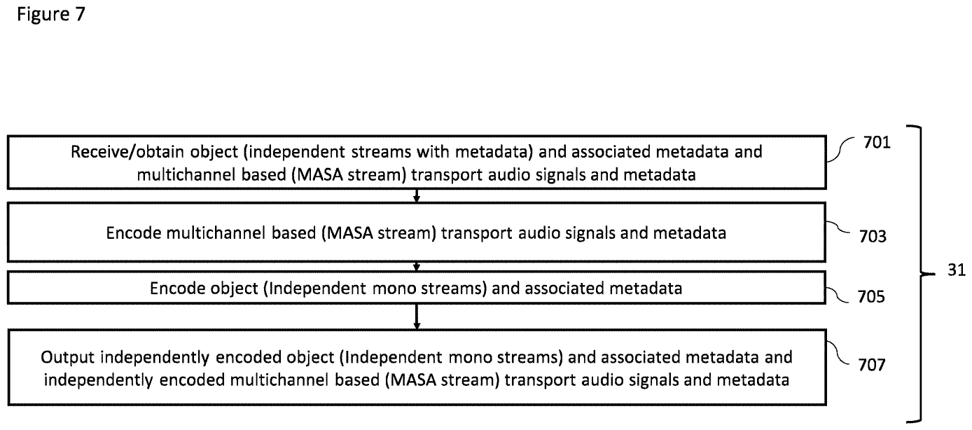

FIG. 7 shows the mode D encoding method, the fourth (or highest or all objects) encoding mode as shown in FIG. 3 by step 310. Thus, in the higher bitrates (for example bitrates above or equal to 160 kbps) the two input audio formats, MASA and ISM are independently encoded and transmitted.

Thus for example there is a method step of receiving/obtaining the object based streams (independent streams with metadata) and multichannel based (MASA stream) transport audio signals and metadata as shown in FIG. 7 by step 701. Then, as shown by step 703 in FIG. 7, there is encoded the multichannel based (MASA stream) transport audio signals and metadata based on any suitable MASA encoding method.

The object (independent streams with metadata) and associated metadata can furthermore be encoded as shown in FIG. 7 by step 705. Any suitable mono encoder (as part of the main encoder) can be employed to implement the encoding, for example an EVS based mono encoder.

The encoder can then output the independently encoded object (independent streams with metadata) and associated metadata and independently encoded multichannel based (MASA stream) transport audio signals and metadata as shown in FIG. 7 by step 707.

With respect to the following the generation and encoding of the ISM ratio values, such as determined and encoded within the encoding modes B and C, is described in further detail.

With respect to the following encoding of the direction metadata parameter associated with the objects (as determined from the ISM metadata) is described and in some embodiments the encoding of the direction metadata parameter associated with the objects when the encoder is operating in the modes B and C (the second or third) encoding modes. However, it would be appreciated that in some embodiments the following can also be applied to any encoding mode where the audio object metadata (and specifically the direction metadata) is encoded. In embodiments where the MASA-to-total ratios and ISM ratios are not sent then extra information on the coding details (bit allocation) is sent. Furthermore, in some embodiments, the ratios could, in principle be calculated from the encoded signals, both at the encoder and at the decoder.

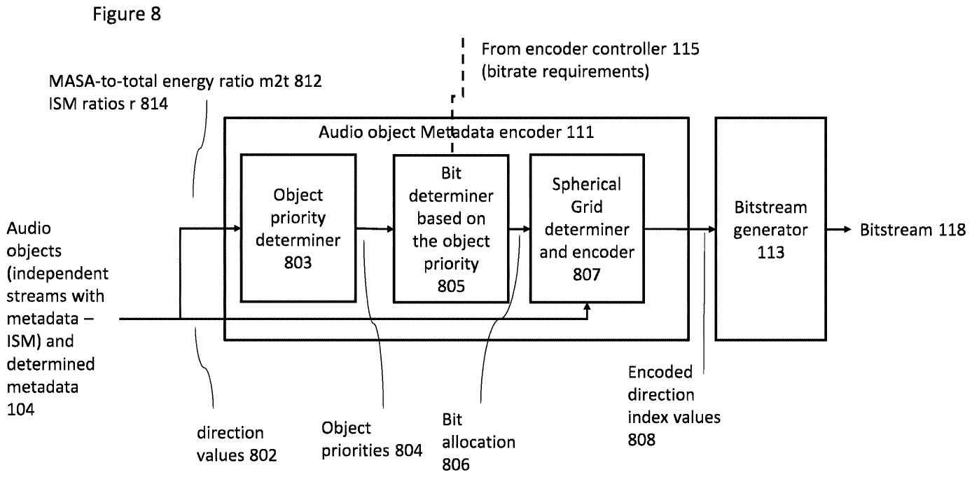

Thus with respect to FIG. 8 is shown in further detail the audio object metadata encoder 111 according to some embodiments. In the following examples the audio object metadata encoder 111 is configured to receive as an input the ISM metadata and specifically the MASA-to-total energy ratio m2t 812, the ISM ratios r 814 and the direction values 802. In other words the ISM metadata comprises directional information (elevation and azimuth) for each object at each frame. There is a standard resolution of 11 bits per elevation-azimuth pair. Additionally, the MASA-to-total ratios and the ISM ratios can be determined or otherwise obtained from the ISM and also from the multichannel audio signals (for example such as described in WO2022/200666).

In some embodiments the ISM ratios can, for example, be obtained as follows.

First, the object audio signals s_{obj}(t, i) are transformed to time-frequency domain S_{obj}(b, n, i) (where t is the temporal sample index, b the frequency bin index, n the temporal frame index, and i the object index. The time-frequency domain signals can, e.g., be obtained via short-time Fourier transform (STFT) or complex-modulated quadrature filterbanks (QMF) (or low-delay variants of them).

Then, the energies of the objects are computed in frequency bands

$${E}_{obj} ( k , n , i ) = {\sum }_{{b}_{k , low}}^{{b}_{k , high}} {\vert {S}_{obj} ( b , n , i ) \vert}^{2}$$

where b_{k,low} is the lowest and b_{k,high} the highest bin of the frequency band k. Then, the ISM ratios ξ(k,n,i) can be computed as

$$ξ ( k , n , i ) = \frac{{E}_{obj} ( k , n , i )}{{\sum }_{i = 0}^{I - 1} {E}_{obj} ( k , n , i )}$$

where I is the number of objects.

For the operating mode when one audio object is separated from the audio object stream comprising multiple audio objects (mode C), the audio object signal 114 of the separated audio object can be zeroed before the above ISM ratio is calculated. That is s_{obj}(t, iₛₒ), where iₛₒ corresponds to the index of the separated audio object, may be set to zero. This can have the effect of removing the prominence of the separated audio object when calculating the above ISM ratios for the remaining audio objects.

In some embodiments, the temporal resolution of the ISM ratios may be different than the temporal resolution of the time-frequency domain audio signals S_{obj}(b, n, i) (i.e., the temporal resolution of the spatial metadata may be different than the temporal resolution of the time-frequency transform). In those cases, the computation (of the energy and/or the ISM ratios) may include summing over multiple temporal frames of the time-frequency domain audio signals and/or the energy values.

The ISM ratios are numbers between 0 and 1 and they correspond to the fraction with which one audio object is active within the audio scene created by all the objects. For each object there is one ISM ratio per frequency sub-band and time subframe. As discussed above the ISM ratios are passed to the audio object metadata encoder 111.

For the operating mode when one audio object is separated from the audio object stream comprising multiple audio objects (mode C), the ISM ratios correspond to the fraction with which one audio object is active within the audio scene created by all the remaining audio objects.

In some embodiments the audio object metadata encoder 111 is configured to encode the MASA-to-total ratios and the ISM ratios, the specific encoding of the ISM ratios and MASA-to-total ratios are not described herein in any further detail. For example, WO2022/200666 describes a suitable MASA-to-total ratio encoding method and GB applications 2217884.2 and 2217905.5 describe suitable ISM ratio encoding method

In some embodiments there is an (audio) object priority determiner 803. The object priority determiner 803 is configured to generate a priority value for the objects in a time-frequency tile. In some embodiments the object priority determiner 803 is configured to obtain the MASA-to-total ratios 812 and the ISM ratios 814. For each time frequency (TF) tile (meaning for each combination subband-subframe) there is one MASA-to-total energy ratio and N ISM ratios, where N is the number of objects.

The priority value can furthermore in some embodiments be defined as the maximum over all time-frequency tiles of the object contribution ratios.

For example a priority value can be generated based on

$$p ( i ) = {{max}_{b = 0 : B - 1 ,}}_{k = 0 : M - 1} ( ( 1 - m 2 t ( b , k ) ) r ( i , b , k ) ) , i = 0 : N - 1$$

In the formula above, there are N objects, B subbands, and M time subframes. m2t(b, k) represents the quantized MASA-to-total energy ratio for subband b and subframe k. r(i, b, k) is the quantized ISM ratio of object i, for subband b and subframe k. In the following the quantized versions of the MASA-to-total and ISM ratios are used in order to have the same values available also at the decoder.

When the encoder controller 115 is operating in the C mode of operation the above expression for p(i) may be used for all audio objects except the separated audio object. In this case p(i) will be calculated for N−2 audio objects.

In some embodiments some other parameter (than the MASA-to-total energy ratio) can be employed. For example, an objects-to-total energy ratio, which could be something like o2t(b,k)=1−m2t(b,k), and would effectively thus carry the same information.

In such embodiments where the alternative parameter is employed, then the equation above is updated accordingly. Thus, in the above object-to-total energy ratio example the object-to-total o2t(b,k) would just replace the (1−m2t(b,k)) part.

Alternatively, in some embodiments a (weighted) average of the object contributions in the TF tiles can also be considered for selecting the priority. Also, in some other embodiments, the max operator can be replaced by a second or third max value (or any similar value). This way, the highest contribution in a single TF-tile would not alone determine the priority.

As mentioned previously the encoder controller 115 can operate in a mode whereby an audio object can be separated from the audio object stream and encoded separately as a single audio object, for example the encoding mode C as given by the processing stage 308 in FIG. 3. In this mode the object priority determiner 803 can be arranged to determine the priority of the separated audio object in a different manner to the other audio objects of the time frame. For instance, the audio object may be given a priority value which reflects its relative subjective importance to the overall audio scene compared to the other multiple audio objects.

As an aside, it is to be noted that when an audio object is determined for separation from the audio object stream 104, the object audio signal of the identified audio object may be faded out from the audio mix (comprising the MASA transport signals 106 and audio object transport audio signals 128 of the audio objects) over the course of a number of time frames. The fading out process may form part of the functionality of the audio object analyser 107 where the object audio signal of the separated audio object is faded out from the audio object transport audio signals. Simultaneously the object audio signal of the separated audio object may be faded in (or phased in) over the course of the same frames to form the separated object audio signal 114. This can also take place in the audio object analyser 107. Alternatively, the processes of removing the separated object audio signal from the audio object transport audio signals 128 and forming the separated object audio signal 114 may be performed as an abrupt change. Details of the moving of object audio signals into and from multiple audio object mixes may be found in the patent application publication WO2022/214730.

The contribution of the object audio signal of the separated audio object to the overall energy of the audio mix will diminish as the separated object audio signal is phased out. However, the relative importance of the separated audio object may remain high since it is not completely removed from the object stream 104 rather it is just removed from the audio mix. In this sense that the accompanying directional metadata should be encoded with a high degree of accuracy when compared to the remaining audio objects of the multiple audio object scene.

As an aside, a particular audio object may be identified for separation (by the audio object analyser 107) from the audio object stream 104 by determining the loudness of each audio object in the stream 104 and selecting the loudest audio object as the audio object to be separated. Details of how this can be performed may be found in the patent application publication WO2022/214730.

The priority assigned to the quantization of the directional metadata of the separated audio object may be determined at least in part by the characteristics of the audio content of the object audio signal associated with the separated audio object. In other words, the audio signal type of the separated object audio signal.

In embodiments the audio signal type of the separated audio object may be determined by analysing the signal characteristics of the separated object audio signal 114. For instance, the audio signal encoder core 110 can have a functionality whereby the input audio signal is categorised into different audio signal types such as that found in the EVS encoder. In essence an encoder such as EVS comprises an audio signal type determiner in order to determine the categorisation of the input audio signal. Examples of audio signal classification from the EVS encoder may include a music signal, an inactive signal, voiced signal, unvoiced signal generic signal and a transition signal. In other embodiments an audio signal type determiner may be a functionality which is deployed outside of an audio signal encoding core.

For example, it may be determined that the audio signal type of the separated object audio signal contains perceptually important audio content, such as active generic speech or music. In this instance it can be preferable to attach a higher priority for the subsequent quantization of the directional metadata associated with the separated audio object. In contrast, if the audio signal type was determined to be perceptually less important, then it would be preferable to attach a lower priority for the subsequent quantization of the directional metadata.

It is to be noted that the priority values for the multiple audio objects given by the equation above can have values between 0 and 1, with the value of 1 being a highest possible priority value that can be assigned to an audio object.

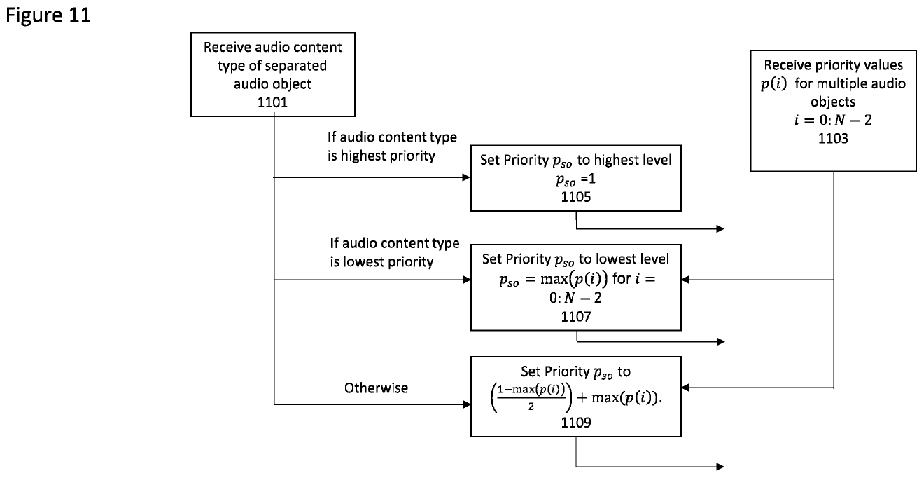

For the separated audio object, the value of the priority pₛₒ may be set in accordance with the audio signal type of the separated audio object rather than using the above equation for p(i). In this respect, FIG. 11 depicts an example of the processing steps which may be performed by the object priority determiner 803 when determining the priority pₛₒ for the quantization of directional metadata associated with the separated audio object. The value of pₛₒ as determined by the object priority determiner 803 for the separated audio object can then be used by the bit determiner 805 to determine the operating resolution of the spherical grid determiner and encoder 807.

To that end, FIG. 11 depicts receiving the audio signal type of the separated audio object as the input step 1101. Also shown in FIG. 11 is the step 1003 of receiving the audio object priorities p(i) for i=0:N−2 of the N−2 audio objects which have not been separated from the audio object stream.

The priority of the separated audio object pₛₒ may then be determined in accordance with the audio signal type.

For instance, the audio signal type may indicate an audio content [of the separated audio object] which warrants setting the priority of the separated audio object pₛₒ to be of the highest priority value. The highest priority value can be set as the maximum possible priority value given by the equation for p(i). In embodiments this maximum possible priority given by the equation for p(i) may be 1.

With reference to FIG. 11, the step of determining whether the separated audio object is associated with an audio signal type which warrants a highest priority value is shown as 1105. Examples of audio content [of the separated audio object] which warrants the highest priority setting may comprise at least one of generic speech or music. In FIG. 11 the highest priority value for the separated audio object priority is shown as pₛₒ=1.

The audio signal type may indicate an audio content which warrants setting the priority of the separated audio object pₛₒ to be of the lowest priority value. The lowest priority value may be determined as the maximum of the priority values for the other audio objects (that is the other audio objects being the multiple audio objects remaining after the removal of the separated audio object). In terms of the above equation for p(i), pₛₒ can be expressed as max(p(i)) over the N−2 remaining audio objects. Note the N−2 remaining audio objects does not include the separated audio object.

With reference to FIG. 11, the step of determining whether the separated audio object warrants the lowest priority is shown as 1107. Examples of audio content which warrants the lowest priority setting may comprise at least one of inactive signal or unvoiced speech. In FIG. 11 the lowest priority value for the separated audio object priority is shown as pₛₒ=max(p(i)) for i=0:N−2.

Furthermore, a third (otherwise) condition can exist for the case when the audio signal type does not satisfy the two former conditions or if there is no audio signal type assigned to the separated object audio signal 114. In this instance the separated audio object priority value pₛₒ may be set as the mid value between the maximum possible priority given by the equation for p(i) (which in the above expression is 1) and the max(p(i)) over the N−2 remaining audio objects. Or alternatively this third condition may set the separated audio object priority value pₛₒ to a predetermined value.

With reference to FIG. 11 this otherwise condition is shown as the processing step 1109 where pₛₒ is shown as taking the value

$$( \frac{1 - max ( p ( i ) )}{2} ) + max ( p ( i ) ) .$$

In some alternative embodiments the separated audio object priority value pₛₒ may be set in a manner which is independent of the audio signal type of the separated object audio signal. In such embodiments the separated audio object priority value pₛₒ may be assigned to a highest possible priority value an example of which (as mentioned above) can the value of one. Other values of the assigned separated audio object priority value pₛₒ may be the above value of

$$( \frac{1 - max ( p ( i ) )}{2} ) + max ( p ( i ) ) .$$

The object priority values 804 can then be passed to a bit determiner 805.

In some embodiments the audio object metadata encoder 111 comprises a bit determiner 805. The bit determiner 805 is configured to obtain or receive the object priorities 804 and based on these object priority values determine the number of bits that can be used to encode the direction parameter. In other words, set the number of bits which defines the quantization grid used to encode the direction values 802.

In some embodiments the bit determiner 805 is configured to determine or assign fewer bits for objects with lower priority.

As an example, based on the audio object priority, the number of bits allocated for each audio object directional metadata can be calculated as:

bits(i)=11−[(1−p(i))*7], i=0:N−1

For the mode C of operation where there is one separated audio object, the number of bits allocated for each audio object directional metadata of the remaining audio objects can be calculated as:

bits(i)=11−[(1−p(i))*7], i=0:N−2

The number of bits allocated for the separated audio object directional metadata can be calculated as

bits=11−[(1−pₛₒ)*7]

The [ ] operator stands for rounding to the nearest integer operation. The maximum number of bits per object direction is 11 and the minimum number of bits is 4. The maximum number of bits and the minimum number of bits can be other values based on the implementation details and thus the value 7 (the difference between the maximum number of bits and the minimum number of bits per object direction) can also change in some other embodiments. Although this example shows a linear scale the formula described above providing the number of bits can be replaced by any other increasing linear or non linear function of the object priority and ensuring the number of bits are within a domain [4,11] or similar.

The bit allocation 806 can then be passed to the spherical grid determiner and encoder 807.

It is to be appreciated that the method of separating a single audio object from the stream audio objects 104 may be extended to include a plurality of single audio objects. That is a number of individual audio objects may be separated from the audio object stream according to their relative loudness values. For example, the M loudest audio objects may be individually separated from the audio object stream 104.

In some embodiments the audio object metadata encoder 111 comprises a spherical grid determiner and encoder 807 configured to receive the bit allocation 806 and the direction values 802. The spherical grid determiner and encoder 807 is then configured to generate an output index value based on the nearest point with respect to the direction values 802 in a determined spherical grid defined by the bit allocation 806 for the object. The encoded direction index values 808 can be output or can be further processed.

Other embodiments may be configured to quantize the direction of each object, with the corresponding number of bits and output an elevation index and an azimuth index. The object metadata can be independently encoded for each object or jointly encoding the objects directional metadata using for instance some weights to correspond to the different bit allocations.

The highest resolution (11 bits) spherical grid used for the direction quantization ensures a quantization resolution of 5 degrees. The structure of the spherical grid is the same as the one used for the quantization of the MASA directional metadata (and methods for defining the grid and encoding the index with respect to MASA directional metadata values are known as discussed in PCT/EP2017/078948, GB1811071.8).

In some embodiments where the priority of an object is exactly zero, the number of bits for that object is set to zero and there is no directional metadata sent for that object.

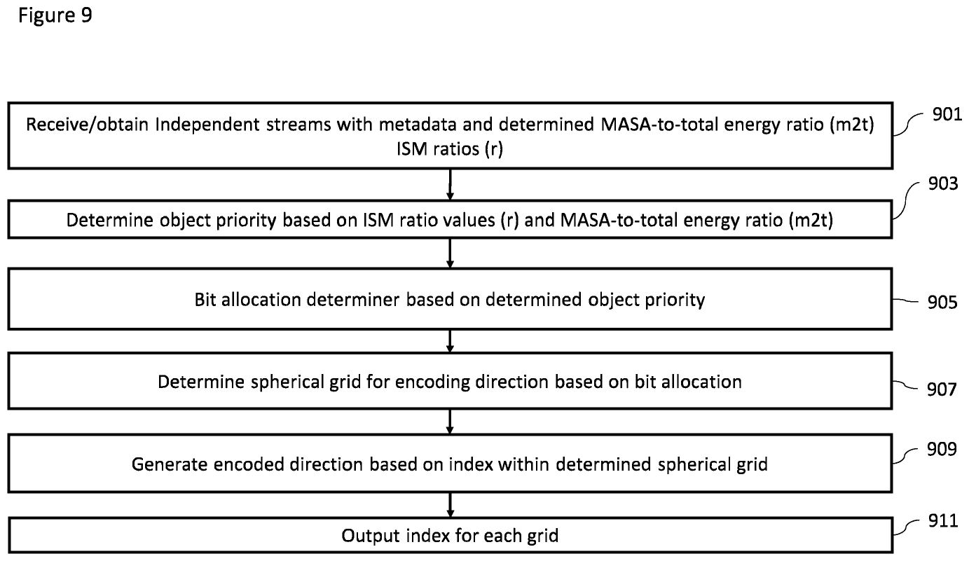

With respect to FIG. 9 is shown a flow diagram which summarises the operations of the example audio object metadata encoder 111 shown in FIG. 8.

The initial operation is one of receiving/obtaining the independent streams with metadata and determined (quantized) MASA-to-total energy ratio (m2t) and ISM ratios (r) as shown in FIG. 9 by step 901.

Then the following operation is determining object priority based on (quantized) ISM ratio values (r) and (quantized) MASA-to-total energy ratio (m2t) as shown in FIG. 9 by step 903.

Having determined the object priority then determine bit allocations for the direction parameter based on determined object priority as shown in FIG. 9 by step 905.

From the bit allocations then determine a spherical grid for encoding direction parameters for the objects as shown in FIG. 9 by step 907.

Then generate encoded direction index within the determined spherical grids as shown in FIG. 9 by step 909.

The encoded direction index values can then be output for inclusion to the bitstream as shown in FIG. 9 by step 911.

With respect to a decoder, the decoding of the encoded directional information can be implemented by determining a similar priority ordering determination and determining the associated quantization grid. Thus for example an encoding and decoding pseudo-code representation can be:

### Object Metadata Encoding

1. For each object
   a. calculate priority p(i)
   b. calculate the number of bits bits(i)
2. End for
3. For each object
   a. Encode the directional metadata in the spherical grid corresponding to the number of bits allocated for the object
4. End for

### Object Metadata Decoding

1. For each object
   a. calculate priority p(i)
   b. calculate the number of bits bits(i)
2. End for
3. For each object
   a. Decode the directional metadata in the spherical grid corresponding to the number of bits allocated for the object
4. End for

In some embodiments, the ISM ratios and/or the MASA-to-total energy ratios can be determined just for determining the priorities in encoding modes other than B and C (for example in encoding mode D). In such embodiments some additional information about the bit allocation is also sent.

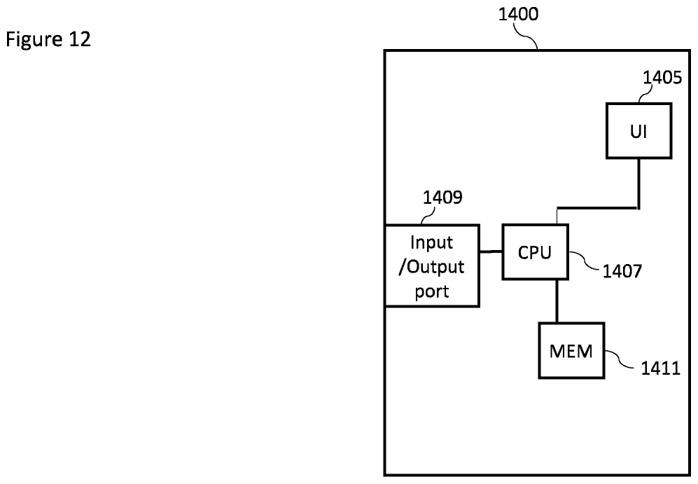

With respect to FIG. 12 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder/analyser part and/or the decoder part as shown in FIGS. 1 and 10 or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (loT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor; and at least one memory storing instructions that, when executed by the at least one processor, cause the apparatus at least to:
receive a plurality of audio objects each comprising a respective audio signal and directional metadata;
separate at least one audio object from the plurality of audio objects to give at least one separated audio object and a remaining plurality of audio objects;
determine a priority value associated for each of the remaining plurality of audio objects;
determine a priority value for the at least one separated audio object dependent on an audio signal type of the audio signal associated with the at least one separated audio object and the priority values of the remaining plurality of audio objects;
determine a quantization bit allocation for directional metadata associated with the at least one separated audio object based on the priority value for the at least one separated audio object; and
quantize the directional metadata associated with the at least one separated audio object based on the quantization bit allocation.

2. The apparatus as claimed in claim 1, wherein the apparatus caused to determine a priority value for the at least one separated audio object dependent on an audio signal type of the audio signal associated with the at least one separated audio object and the priority values of the remaining plurality is caused to:
determine whether the audio signal type of the audio signal associated with the at least one separated audio object warrants a highest priority value; or
determine whether the audio signal type of the audio signal associated with the at least one separated audio object warrants a lowest priority value; or
otherwise determine that the separated audio object has a further priority value.

3. The apparatus as claimed in claim 2, wherein the highest priority value is a highest priority value that can be determined for an audio object of the remaining plurality of audio objects.

4. The apparatus as claimed in claim 2, wherein the highest priority value is one;

5. The apparatus as claimed in claim 2, wherein the lowest priority value is a maximum priority value of the priority values of the remaining audio objects;

6. The apparatus as claimed in claim 2, wherein the further priority value is the mid value between a highest priority value that can be determined for an audio object of the remaining plurality of audio objects and a maximum priority value of the priority values of the remaining audio objects.

7. The apparatus as claimed in claim 2, wherein the further priority value is a predetermined value.

8. The apparatus as claimed in claim 2, wherein the apparatus is further caused to:
encode the audio signal of the at least one separated audio object using an audio encoder, and
analyse the audio signal of the at least one separated audio object using an audio signal type determiner from the audio encoder.

9. A method comprising:
receiving a plurality of audio objects each comprising a respective audio signal and directional metadata;
separating at least one audio object from the plurality of audio objects to give at least one separated audio object and a remaining plurality of audio objects;
determining a priority value associated for each of the remaining plurality of audio objects;
determining a priority value for the at least one separated audio object dependent on an audio signal type of the audio signal associated with the at least one separated audio object and the priority values of the remaining plurality of audio objects;
determining a quantization bit allocation for directional metadata associated with the at least one separated audio object based on the priority value for the at least one separated audio object; and
quantizing the directional metadata associated with the at least one separated audio object based on the quantization bit allocation.

10. The method as claimed in claim 9, wherein determining a priority value for the at least one separated audio object dependent on an audio signal type of the audio signal associated with the at least one separated audio object and the priority values of the remaining plurality comprises:
determining whether the audio signal type of the audio signal associated with the at least one separated audio object warrants a highest priority value; or
determining whether the audio signal type of the audio signal associated with the at least one separated audio object warrants a lowest priority value; or
otherwise determining that the separated audio object has a further priority value.

11. The method as claimed in claim 10, wherein the highest priority value is a highest priority value that can be determined for an audio object of the remaining plurality of audio objects.

12. The method as claimed in claim 10, wherein the highest priority value is one;

13. The method as claimed in claim 10, wherein the lowest priority value is a maximum priority value of the priority values of the remaining audio objects;

14. The method as claimed in claim 10, wherein the further priority value is the mid value between a highest priority value that can be determined for an audio object of the remaining plurality of audio objects and a maximum priority value of the priority values of the remaining audio objects.

15. The method as claimed in claim 10, wherein the further priority value is a predetermined value.

16. The method as claimed in claim 9, wherein the method further comprises:
encoding the audio signal of the at least one separated audio object using an audio encoder, and
analysing the audio signal of the at least one separated audio object using an audio signal type determiner from the audio encoder.
